(19) United States
(12) Patent Application Publication
(10) Pub. No.: US 2015/0160990 A1
(43) Pub. Date: Jun. 11, 2015

(54) Virtual Computer Technical Support Agent

(71) Applicant: Karim Massoud, Aventura, FL (US)

(72) Inventor: Karim Massoud, Aventura, FL (US)

(21) Appl. No.: 14/097,266

(22) Filed: Dec. 5, 2013

(51) Int. Cl. G06F 11/07

(52) U.S. Cl. CPC G06F 11/079

(57) ABSTRACT

The invention disclosed herein enables to connect, control, diagnose and repair mulfunction computer or other electronic device from most of the problem that can't be fixed by technical support over the internet and it require an agent or technician to be present on site to diagnose and repair the existing problem.

### BACKGROUND OF THE INVENTION

1. Field of Invention

The invention relates generally to remote, technical support for a user of a computer or other electronic device, and deals more particularly with such support provided by a support agent acting through another computer.

2. Description of the Related Art

Technical support is often required for users of a computer such as desktop or laptops or other electronic devices. This online technical support may be to fix or diagnose a faulty of an application or software running on the user's computer.

many companies currently using few methods to provide technical support to users 1^{st} over the internet which require user to browse the internet to specific website using internet browser to download and install remote access program or screen sharing application to give the technical support agent the ability to see and take control over user's computer.

2^{nd} method is on-site support where a technician or technical support agent visits the premises of the customer/user and works directly with on the user's computer.

3^{rd} method is to call a help desk center and speak to a technical support agent to guide and explain to the user how to solve the problem.

The problem with 1^{st} method online technical support such screen sharing which require internet access and functional internet browser to download and install specific program via web browser which most of the time will be blocked if customer have issue caused by viruses or malware or any other problems that cause the users not to have internet access or working internet browser to start the remote access session or some users may not want the technical support agent to control their computer but the biggest obstacle to users if they have problem with the operating system which will not allow them do any thing on there computer and leave them nothing but black screen (DOS/BIOS) mode or Blue screen of death which it keeps restarting the computer and put it in loop hole which some times there no way around it.

The problem with the 2^{nd} method that it's most costly which most of the users can't afford because of the hourly rate and it require the user or some one to be present as long as the agent present.

The problem with the 3^{rd} method which the most unpreferred because the technical support agent is unable to see the display screens of the user's computer and the hassel that will cause to the user while he try to do what the agent asking him to do trying to guide him to fix the problem with the terminology spoken by the technical support agent also which yet will be the impossible mission if the operating system is not working or the user may facing with the same issue that explained within the 1^{st} method.

Therefore, the present invention is to provide an revolutionary method to deliver an easy and effective technical support to remote users computers and electronic devices without the hassel of dealing of any of pervious methods.

### SUMMARY OF INVENTION

The invention resides in a technique for supporting a user by connecting the user's computer via USB (Universal Serial Bus) port and video source port VGA (Video Graphics Array) directly with the main device. A current realtime capture screen of user's computer will be redirected and sent to agent through the main device internet connection and full control of user computer USB port which will be used as data transfer port or external boot media device and input device such as keyboard to change computer settings and modes such as DOS or BIOS or Safe Mode or even windows installation mode or any other diagnostic and repair modes required for the technical support steps.

According to one feature of the present invention, the main device have audio microphone and speaker functionality to give the agent the ability to hear and identify any sound codes generated by user computer in some hardware failure problem also will allow live audioable communication between user and agents incase of any additional instruction required to be done by users during the support session.

According to another feature of the present invention, the main device have built in independent wireless internet connection for direct access to device without requiring internet connection in user location if user does not have internet connection

### BRIEF DESCRIPTION OF THE DRAWINGS

FIG. 1 illustrates environment in which the present invention may be applied with user's computer

FIG. 2 a flow chart illustrating steps taken by a user and technical support agent at their respective computers and operation accordance with the present invention.

### DETAILED DESCRIPTION OF THE PRESENT INVENTION

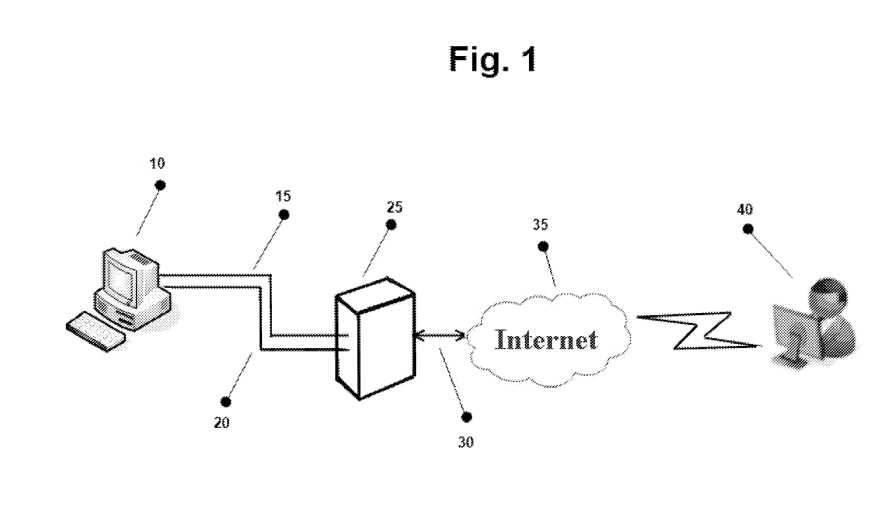

FIG. 1 is a block diagram of user's computer and present invention. User's computer 10 connected directly to the invention device 25 by plugging USB (Universal Serial Bus) cable 15 and VGA (Video Graphics Array) cable 20 between the user's computer 10 and the device 25 then connecting the device 25 with an internet connection source 30 such as (LAN) local area network to provide internet connectivity 35 for data communication between device 25 and the agent computer 40. The local area network (LAN) connection can be a high speed Ethernet network or any other suitable connection. User “computer” 10 can be various data processing, communication or electronic application devices such as desktop computers, laptop computers, DVRs, etc. as found in many existing environment.

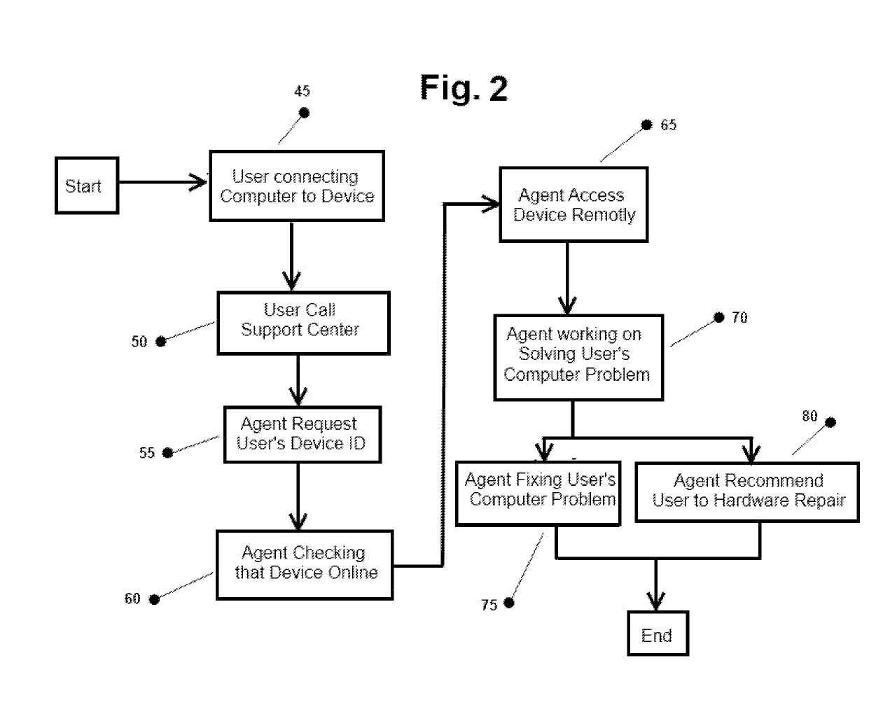

FIG. 2 is a flowchart illustrating the steps of the technical support process accordance with the present invention. When a user needs technical support to diagnose, solve, repair mulfunction computer or other electronic device , the user connect the computer directly to device (present invention) 45 following by calling the technical support center for assist 50 which will require user to provide device ID (Identification Number) to Agent when requested 55. Once the Agent check device ID (Identification Number) and check if it's ON and online 60 via internet access then agent will proceed next stage by remotely connecting to the main device 65 using remote access application which make agent able to control the device and instantly see what the device capturing via VGA (Video Graphics Array) cable from the user computer and will be able to send signal via USB (Universal Serial Bus) port to behave as External USB storage media as a diagnostic boot device and as external keyboard to change computer setting into all modes that does not support internet connection such as BIOS (Basic Input/Output System), Operating system installation and any additional Sub-Modes which the most unique and effective function in present invention. So by agent being able to see what computer present problem he will proceed with the best method to diagnose and fix the user existing problem 75 by controlling and directing the computer setting and upload the necessary files to the system to make the computer operational and repair it or will recommend the user with the any additional requirement if computer require hardware repair 80

1. A computer apparatus product, takes control over a target device such as computer (laptop and desktop) or other electronics device via input ports USB (Universal Serial Bus) and output video source ports VGA (Video Graphics Array) and give the controller the ability to see realtime images of user remote computer and send data signal to diagnose and fix the existing problem without being present onsite or requiring the target computer to have internet connection or operational operating system to fix it.
